(19) United States
(12) Patent Application Publication
(10) Pub. No.: US 2016/0076571 A1
(43) Pub. Date: Mar. 17, 2016

(54) INSERT KIT AND INSTALLATION METHOD

(71) Applicant: Paul Martin, Aldridge (GB)

(72) Inventor: Paul Martin, Aldridge (GB)

(73) Assignee: PSM IP LIMITED, Road Town (VG)

(21) Appl. No.: 14/949,363

(22) Filed: Nov. 23, 2015

Related U.S. Application Data
(63) Continuation of application No. 12/991,979, filed on Nov. 10, 2010, now Pat. No. 9,194,419.

(51) Int. Cl. F16B 19/00; F16B 13/02

(52) U.S. Cl. CPC F16B 19/00; F16B 13/02

(57) ABSTRACT

An insert (100) having a first insert portion (102) a second insert portion (104) and a third insert portion (106) for installation into a first bore portion (136), a second bore portion (138) and a third bore portion (140) respectively in which the first bore portion (136) is larger than the second and third insert portions (104, 106) and the second bore portion (138) is larger than the third insert portion (106).

### CROSS REFERENCE TO RELATED APPLICATION

The present application is a continuation of U.S. patent application Ser. No. 12/991,979, which is a national phase conversion of PCT/GB2009/01166, filed May 12, 2009, which claims priority of United Kingdom Patent Application No. 0809001.1, filed May 16, 2008 the contents of which are incorporated herein by reference. The PCT International Application was published in the English language.

### BACKGROUND OF THE INVENTION

1. Field of the Invention

The present invention relates to an insert. More specifically, the present invention relates to inserts for installation into components made from plastics materials.

2. Description of the Related Art

Metal inserts are commonly used for the attachment of components constructed from plastics materials. Plastics materials are not particularly well suited to the formation of mechanical joining features such as threads as they have relatively low stiffness and strength compared to metals. As such, it is common practice to permanently install metal inserts into plastic components to provide mechanical joining features. These metal inserts have internal mechanical joining features such as threads.

Inserts are commonly cylindrical in form and comprise features on their external surface to inhibit movement between the insert and the plastic component (anti-movement features). These may be circumferential features to provide pull-out resistance or axial features for torque resistance. Such features may have both circumferential and axial parts, such as knurls.

Metal inserts of the type described above are used in many applications such as vehicle assembly—e.g. interior trim.

Such metal inserts are commonly installed into the plastic components by locally heating the insert and/or the plastics material and forcing the insert into the component. The semi-fluid plastics material then flows around locking features of the insert and cools to provide a permanent mechanical bond between the component and the insert. Another known method is to vibrate the insert at a high frequency to create frictional heating at the insert-plastic boundary. This heating causes the plastics material to melt and flow around the insert external features before cooling and solidifying to form a bond.

Heat is applied to the insert prior to installation to heat the insert to a temperature above the softening point temperature of the plastics material. As the insert is installed, the plastic material draws heat from the insert and softens to flow around the insert external profile. The amount of energy required to complete the installation is therefore influenced by the time taken to complete the installation process. The time taken to install the insert is controlled by the insert design and the distance the insert travels during the insertion process.

A problem with such installation techniques is that the distance the insert must travel is generally equal to the length of the insert, and as such a significant amount of energy needs to be used to heat the insert in order to install it. Much of the insert is not contacting the plastics material during installation and as such the heat may be dissipated to the surrounding environment.

Alternatively, ultrasonic energy may be used to heat the insert and surrounding plastics material during installation. Therefore ultrasonic energy must be supplied during the entire installation. As such, as the entire insert must be vibrated for the entire time it takes to fully install the insert. This is not energy efficient as, particularly during the initial stages of installation, much of the length of the insert is not contacting the plastics material.

It is an aim of the present invention to overcome or at least mitigate the above problem.

### BRIEF SUMMARY OF THE INVENTION

According to a first aspect of the invention there is provided an insert assembly kit comprising; a generally cylindrical stepped insert having; a first cylindrical insert portion of a first insert diameter, a second cylindrical insert portion of a second insert diameter, and a third cylindrical insert portion of a third insert diameter, in which the first insert diameter is greater than the second and third insert diameters, the second insert diameter is greater than the third insert diameter, and the second insert portion is positioned axially between the first and third insert portions, the insert assembly further comprising; a plastics part having a generally cylindrical stepped bore defining; a first cylindrical bore portion of a first bore diameter, a second cylindrical bore portion of a second bore diameter, and a third cylindrical bore portion of a third bore diameter, in which the first bore diameter is greater than the second and third bore diameters, the second bore diameter is greater than the third bore diameter, and the second bore portion is positioned axially between the first and third bore portions, wherein the first, second and third bore diameters are smaller than the first, second and third insert diameters respectively to engage and thereby retain the insert upon installation into the plastics part, and; wherein the first bore diameter is greater than second and third insert diameters, and the second bore diameter is greater than the third insert diameter such that the second and third insert portions are freely positionable within the first and second bore portions respectively.

Advantageously, the insert may be freely inserted into the bore before heating and/or vibration commences. To install the insert, energy only needs to be provided to the insert for a length of time necessary for the longest insert portion to be installed.

The fact that the first bore diameter is larger than both the first and second insert diameters assists in location of the insert within the bore, and alignment of the two components. As such, a less precise tolerance can be used to produce i) moulded hole centres in the host plastic component and ii) implement insert positioning relative to the moulded hole during insertion.

The first, second and third insert and/or bore portions may be substantially equal in axial length. As such, the amount of heat energy required to successfully install the insert is less as the first, second and third portions are simultaneously installed. Further, the amount of ultrasonic energy only needs to be supplied to the insert for a fraction (approximately one third) of the time taken to install a known insert, as the first, second, and third portions are installed simultaneously.

According to a second aspect of the invention there is provided a method of installation of an insert into a plastics component comprising the steps of: providing a generally cylindrical stepped insert having; a first cylindrical insert portion of a first insert diameter, a second cylindrical insert portion of a second insert diameter, and a third cylindrical insert portion of a third insert diameter, in which the first insert diameter is greater than the second and third insert diameters, the second insert diameter is greater than the third insert diameter, and the second insert portion is positioned axially between the first and third insert portions, providing a plastics part having a generally cylindrical stepped bore defining; a first cylindrical bore portion of a first bore diameter, a second cylindrical bore portion of a second bore diameter, and a third cylindrical bore portion of a third bore diameter, in which the first bore diameter is greater than the second and third bore diameters, the second bore diameter is greater than the third bore diameter, and the second bore portion is positioned axially between the first and third bore portions, wherein the first, second and third bore diameters are smaller than the first, second and third diameters respectively, and, in which the first bore diameter is greater than second and third insert diameters, and the second bore diameter is greater than the third insert diameter, freely positioning the second and third insert portions within the first and second bore portions respectively, and; installing the insert into the bore to engage the first, second and third insert portions with the first, second and third bore portions to thereby engage and retain the insert.

### BRIEF DESCRIPTION OF THE SEVERAL VIEWS OF THE DRAWINGS

An example insert kit and installation method in accordance with the present invention will now be described with reference to the accompanying figures in which:

FIG. 1 is a side view of a first embodiment of an insert in accordance with the present invention,

FIG. 2 is a side view of a second embodiment of an insert in accordance with the present invention,

FIG. 3 is a side view of the insert of FIG. 1,

FIG. 4 is a side section view of a part of a plastic component in accordance with the present invention,

FIG. 5 is a partially sectioned side view of the insert of FIG. 3 at a first stage of engagement with the plastic component of FIG. 4,

FIG. 6 is a view similar to FIG. 5 at a second stage of engagement, and;

FIG. 7 is a view similar to FIG. 5 at a third stage of engagement.

### DETAILED DESCRIPTION

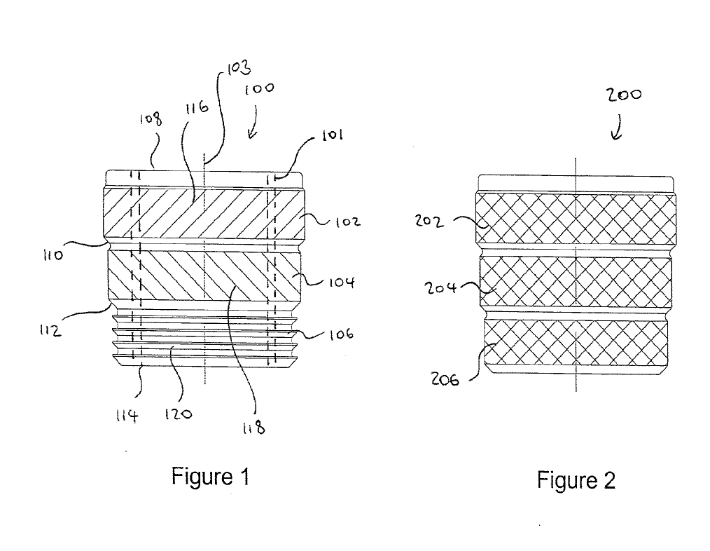

Referring to FIG. 1, and insert 100 has a generally cylindrical body about a main axis 103 comprising a first insert portion 102, a second insert portion 104 and a third insert portion 106 which are all generally cylindrical and of equal length of approximately one third of the total insert lenth. The insert 100 is hollow, and defines an open threaded bore 101. The insert 100 defines an entry area 108 for the mating of a male threaded member into the threaded bore. The first insert portion 102 is connected to the entry area 108, and to a neck 110 which connects it to the second insert portion 104. The second insert portion 104 is connected to a shoulder 112. The shoulder 112 connects to the third insert portion 106. The third insert portion 106 terminates in an end region 114.

The first insert portion 102 defines helical grooves 116 on its outer surface. The second insert portion 104 defines opposing helical grooves 118 on its outer surface. The third insert portion 106 defines annular ribs 120 on its outer surface.

Referring to FIG. 2, an insert 200 is substantially similar to the insert 100 but knurls are defined on each of the first, second and third insert portions 202, 204, 206.

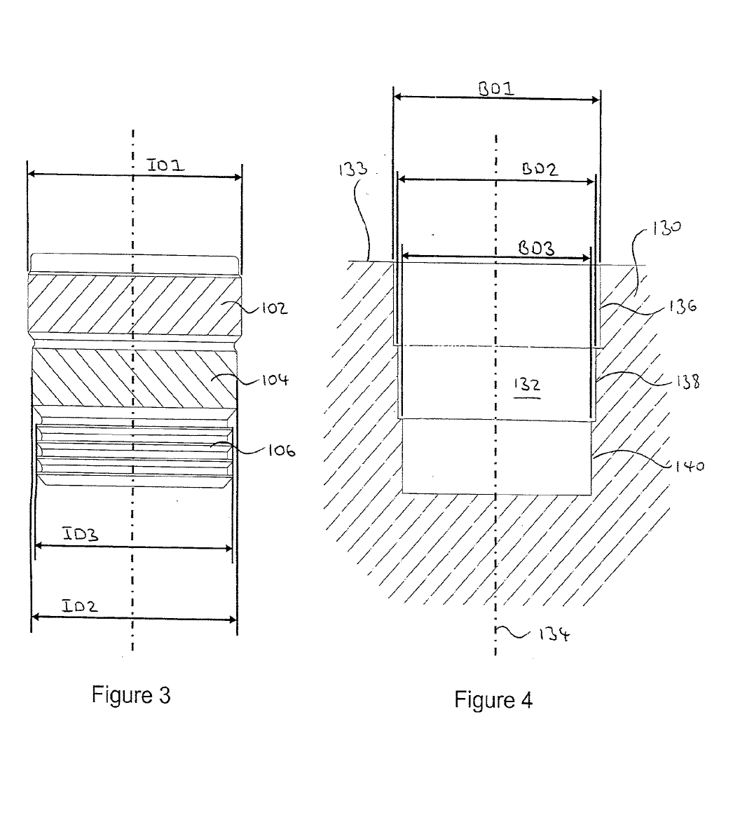

Referring to FIG. 3, the insert 100 is shown with the diameters of the first, second and third insert portions 102, 104, 106 shown as ID1, ID2 and ID3 respectively.

Referring to FIG. 4, a component 130 is shown constructed from plastic material and defining a blind bore 132 extending from a surface 133. The blind bore 132 is generally cylindrical about a main axis 134 and comprises a first bore portion 136, a second bore portion 138 and a third bore portion 140. The first bore portion 136 is proximate the surface 133 and the third bore portion is furthest from the surface 133. The diameters of the first, second and third bore portions 136, 138, 140 are BD1, BD2 and BD3 respectively.

It should be noted that:

BD1<ID1,

BD2<ID2,

BD3<ID3 to an extent that a bond between the component 130 and the insert 100 is formed upon installation, as will be described below;

BD1>ID2,

BD1>ID3 such that the second and third insert portions 104, 106 can be freely inserted into the first bore portion 136, and;

BD2>ID3 such that the third insert portion 106 can be freely inserted into the second bore portion 138.

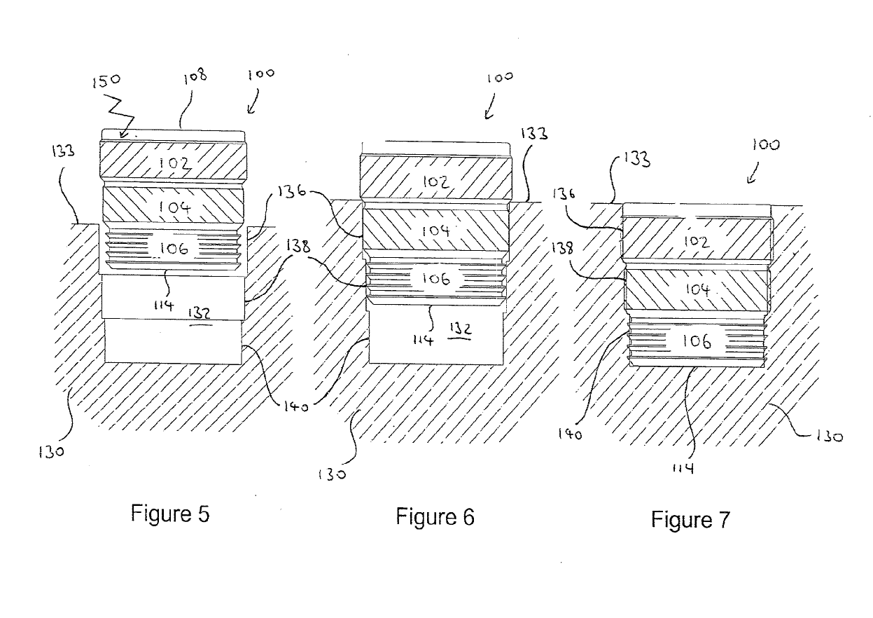

Referring now to FIGS. 5 to 7 which show the installation process. FIG. 5 shows the insert 100 being guided into the bore 132. As can be seen the insert can be freely moved into the bore as the third insert portion 106 is substantially smaller than the first bore portion 136.

In order to install the insert 100 fully into the bore 132, the insert must be supplied with heat from a heat source 150 before installation (shown schematically). The heat source 150 heats the insert 100 to an installation temperature.

Moving onto FIG. 6, the insert 100 has now been freely inserted by two thirds of its axial length as the second insert portion 104 and the third insert portion 106 fit into the first bore portion 136 and the second bore portion 138 respectively. At this point, the insert 100 cannot travel any further into the bore 132 as the bore portions 136, 138 and 140 are smaller than their respective insert portions 102, 104, 106.

Consequently as the insert 100 is installed, the plastics material of the component 130 surrounding the insert 100 softens. The insert 100 is then installed into the bore 132 by a further length equal to one third of the length of the insert 100. As this occurs, the first, second and third insert portions 102, 104, 106 are installed simultaneously.

The installed insert is shown in FIG. 7. It should be noted that the opposing torque resistant helical grooves 116, 118 are located on the first and second insert portions 102, 104 respectively, thus advantageously providing torque resistance at a larger diameter than the third insert portion 106.

Variations of the above embodiment fall within the scope of the present invention.

The insert and bore may have more than three portions, thus further decreasing the installation depth. It should be noted that any less than three corresponding portions would not be sufficient to achieve the benefits of reduced installation distance and improved alignment. Three portions however is a practical optimum which results in the benefits described whilst not requiring an excessive number of machining operations to form the portions.

The insert may be ultrasonically vibrated instead of or as well as heated during installation.

The insert outer surface may be knurled, have ribs, or any combination thereof

The portions do not have to be the same length, for example, the first and second portions may make up 70% of the total length of the portions and the third portion 30%.

The bore 132 may be a through bore.

What is claimed:

1. An insert assembly kit comprising:
a generally cylindrical stepped insert having:
a first cylindrical insert portion having a first cylindrical periphery, a first insert portion diameter, and a first insert portion axial length, and the first insert portion diameter extending over the first insert portion axial length,
a second cylindrical insert portion having a second cylindrical periphery, a second insert portion diameter, and a second insert portion axial length, and the second insert portion diameter extending over the second insert portion axial length,
a third cylindrical insert portion having a third cylindrical periphery, a third insert portion diameter, and a third insert portion axial length, and the third insert portion diameter extending over the third insert portion axial length,
the first insert portion diameter is larger than the second and third insert portion diameters, the second insert portion diameter is larger than the third insert portion diameter, and the second insert portion is positioned axially along the insert between the first and third insert portions,
the insert assembly kit further comprising:
a plastics part having a generally cylindrical, stepped bore defining:
a first cylindrical bore portion having a first bore portion diameter and a first bore portion axial length, and the first bore portion and the first insert portion are each configured such that the entire first insert portion is to be inserted into and received in the first bore portion,
a second cylindrical bore portion having a second bore portion diameter and a second bore portion axial length, and the second bore portion and the second insert portion arc each configured such that the entire second insert portion is to be inserted into and received in the second bore portion, and
a third cylindrical bore portion having a third bore portion diameter and a third bore portion axial length, and the third bore portion and the third insert portion are each configured such that the entire third insert portion is to be inserted into and received in the third bore portion;
the first bore portion diameter is larger than the second and third insert portion diameters and larger than the second and third bore portion diameters; the second bore portion diameter is larger than the third insert portion diameter and larger than the third bore portion diameter; and the second bore portion is positioned axially between the first and the third bore portions;
each of the first, second and third cylindrical insert portions is configured such that each of the insert portions is the only one of the insert portions respectively configured to be received in a respective one of the first, second and third bore portions;
the first, second and third bore portion diameters arc smaller respectively than the first, second and third insert portion diameters, and the bore portions are configured to engage and thereby retain the respective insert portions in the respective bore portions upon full insertion of the stepped insert into the plastics part; and
the cylindrical periphery of at least one of the first, second and third insert portions includes a respective movement resistant feature on the cylindrical periphery, the movement resistant feature on the at least one of the insert portion cylindrical peripheries comprises at least one of a torque resistant feature configured to resist torque on the insert when the insert is in the bore and a pull out resistant feature configured to resist the insert being pulled out of the bore when the insert is in the bore.

2. The insert assembly kit of claim 1, further comprising the torque resistant feature on the at least one of the insert portion cylindrical peripheries is configured such that with the at least one of the insert portion cylindrical peripheries engaging the respective bore portion for the at least one of the insert portion cylindrical peripheries, the respective torque resistant feature is configured to resist torque on the insert.

3. The insert assembly kit of claim 1, further comprising for the pull out resistant feature, the at least one of the insert portion cylindrical peripheries is configured such that with the at least one of the insert portion cylindrical peripheries engaging the respective bore portion for the at least one of the insert portion cylindrical peripheries, the respective pull out resistant feature is configured to resist pull out of the insert from the respective bore portion.

4. The insert assembly kit of claim 1, further comprising:
each of the cylindrical peripheries of each of the insert portions has both of a torque resistant feature and a pull out resistant feature thereon.

5. The insert assembly kit of claim 3, further comprising both of the torque resistant feature and the pull out resistant feature comprise the cylindrical periphery of the at least one of the insert portions comprising respective grooves in the cylindrical periphery of the at least one of the insert portions and each of the grooves is inclined and wraps in a direction around the respective cylindrical periphery.

6. The insert assembly kit of claim 5, wherein the grooves are inclined to a line parallel to a longitudinal axis of the insert, and the inclines of respective different ones of the grooves are inclined in opposed directions.

7. The insert assembly kit of claim 5, further comprising a first set of the grooves inclined in one direction and a second set of the grooves inclined in an opposed direction, wherein the grooves inclined respectively in opposed directions intersect and define a knurl on each of the peripheries, and the knurl defines both the torque resistant and the pull out resistant features on each of the cylindrical peripheries.

8. The insert assembly kit of claim 7, further comprising a respective first and a respective second set of the grooves being in the respective cylindrical periphery of each of the insert portions.

9. The insert assembly kit of claim 5, wherein the grooves are inclined to a line parallel to a longitudinal axis of the insert.

10. The insert assembly kit of claim 5, further comprising both of the torque resistant feature and the pull out resistant feature comprise the cylindrical periphery of the at least one of the insert portions comprising respective grooves in the cylindrical periphery of the at least one of the insert portions and each of the grooves is a helical groove in the cylindrical periphery.

11. An assembly of a plastics part having a generally cylindrical, stepped bore with a generally cylindrical, stepped insert installed in the stepped bore, the assembly comprising:
the stepped insert comprising a first, a second and a third cylindrical insert portion in a series in an axial direction of the insert, each insert portion having a respective cylindrical periphery with a respective diameter, the first insert portion having a first larger diameter periphery, the second insert portion having a second intermediate diameter periphery, and the third insert portion having a third smaller diameter periphery, the insert portions being in series such that the third insert portion leads the second insert portion which leads the first insert portion, in a direction of insertion into the bore into the plastics part;
the stepped bore in the plastic part comprising a first bore portion in which the first insert portion is installed, a second bore portion in which the second insert portion is installed, and a third bore portion in which the third insert portion is installed and, as installed, the first, second and third bore portions having respective diameters that are related to the respective first, second and third insert portions so that the plastics part at the first, second and third bore portions firmly engages the respective peripheries of the first, second and third insert portions in the respective bore portions;
each of the first, second and third insert portions being entirely in the respective first, second and third bore portions; and
the cylindrical periphery of at least one of the insert portions includes at least one of a torque resistant feature, which is configured to engage in and engages the material defining the respective bore portion for resisting torque on the insert portion in the bore portion; and the cylindrical periphery of at least one of the insert portions has a pull out resistant feature, which is configured to engage in and engages the material defining the respective bore portion for resisting subsequent pull out of the insert from the bore.

12. The assembly of claim 11, further comprising the torque resistant feature on the at least one of the insert portion cylindrical peripheries is configured such that with the at least one of the insert portion cylindrical peripheries engaging the respective bore portion for the at least one of the insert portion cylindrical peripheries, the respective torque resistant feature is configured to resist torque on the insert.

13. The assembly of claim 11, further comprising both of the torque resistant features and the pull out resistant features on the at least one of the insert portion cylindrical peripheries together comprise first grooves inclined in one direction and second grooves inclined in an opposed direction, wherein the grooves inclined respectively in opposed directions intersect and define a knurl on each of the peripheries, and the knurl defines both the torque resistant and the pull out resistant features on each of the cylindrical peripheries.

14. The assembly of claim 13, wherein the grooves are inclined respectively in opposed directions intersect and define a knurl on each of the peripheries, and the knurl defines both the torque resistant and the pull out resistant features on each of the cylindrical peripheries.

15. The assembly of claim 13, further comprising a respective first and a respective second set of the grooves being in the respective cylindrical periphery of each of the insert portions.

16. The assembly of claim 11, further comprising for the pull out resistant feature, the at least one of the insert portion cylindrical peripheries is configured such that with the at least one of the insert portion cylindrical peripheries engaging the respective bore portion for the at least one of the insert portion cylindrical peripheries, the respective pull out resistant feature is configured to resist pull out of the insert from the respective bore portion.

17. The assembly of claim 15, wherein the pull out resistant feature comprises at least one rib on the at least one of the insert portion cylindrical peripheries and configured thereon to resist the pull out.

18. A method of installing an insert into a bore, comprising:
providing an insert comprising a stepped, generally cylindrical shape and comprised of three cylindrical insert portions in a series axially along the insert, including a first insert portion with a first larger diameter cylindrical periphery, a second insert portion with a second intermediate diameter cylindrical periphery, and a third insert portion with a third smaller diameter periphery, the third smaller diameter periphery insert portion leading a direction of installation of the insert into the bore and also leading the second intermediate diameter insert portion into the bore and the second insert portion including leading the first larger diameter insert portion into the bore;
providing a plastics part including a stepped bore therein, the plastics part being comprised of a plastics material that is heatable, and softenable when heated, around the bore such that the bore is softenable;
the bore comprises a first, larger diameter bore portion, a second intermediate diameter bore portion, and a third smaller diameter bore portion, wherein the bore portions are arranged in the respective series arrangement of the insert portions;
each bore portion is of a respective diameter and axial length and each bore portion is configured to receive completely the respective first, second and third insert portions within each of the first, second and third bore portions;
the first bore portion diameter is larger than the second and third insert portion diameters and larger than the second and third bore portion diameters and smaller than the first insert portion diameter;
the second bore portion diameter is larger than the third insert portion diameter, larger than the third bore portion diameter, smaller than the first bore portion diameter and smaller than the second insert portion diameter;
the second bore portion is positioned axially between the first and the third bore portions;
the method comprising:
inserting the insert into the bore, by leading the insertion with the third insert portion, wherein the third insert portion passes through the first and the second bore portions without being prevented in the first or second bore portions from the passing, the second insert portion passes through the first bore portion without being prevented in the first bore portion from the passing, and the third insert portion is prevented from moving into the third bore portion by the respective diameters of the third insert portion and the third bore portion;
heating the plastics part at the bore therein to sofen plastics material at the bore, and when the material at the bore is softened, then pushing the insert into the bore so that the third insert portion is received in the third bore portion, the second insert portion is received in the second bore portion and the first insert portion is received in the first bore portion, by the pushing of the insert into the bore while the bore is malleable and until the third insert portion is entirely installed in the third bore portion, the second insert portion is entirely installed in the second bore portion and is prevented from entering the third bore portion and the first insert portion is entirely installed in the first bore portion and is prevented from entering the second bore portion; and
then allowing the plastics part bore to cool and contract at the bore and become firmly secured around the peripheries of the insert portions.

19. The method of claim 18, wherein, at least one of the insert portion cylindrical peripheries is provided with movement resistant features comprising at least one of a torque resistant feature and a pull out resistant feature; and
the method further comprising after the heating and softening of the bore and after the insertion by the pushing of the insert into the bore, then allowing the softened bore to cool and contract and then engage the movement resistant features for securing the insert against moving inside of or out of the bore.
